(19) United States
(12) Patent Application Publication
(10) Pub. No.: US 2008/0208756 A1
(43) Pub. Date: Aug. 28, 2008

(54) APPARATUS AND METHOD FOR PROVIDING SECURITY DOMAIN

(75) Inventors: Jong-tae KIM, Seoul (KR); Sang-dok MO, Suwon-si (KR); Sung-min LEE, Suwon-si (KR); Bok-deuk JEONG, Yongin-si (KR); Sang-bum SUH, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/844,711

(22) Filed: Aug. 24, 2007

(30) Foreign Application Priority Data
Feb. 26, 2007 (KR) 10-2007-0019227

(51) Int. Cl. G06Q 10/00

(52) U.S. Cl. 705/59; 705/51

(57) ABSTRACT

An apparatus and method for providing a security domain are provided. The apparatus includes a security domain which is not connected to an external system and which manages a digital rights management (DRM) license requiring security; a non-security domain which can be connected to the external system and which manages encrypted DRM content; and a virtual controller which controls the security domain and the non-security domain. The method includes requesting checking of a license for encrypted content; checking whether the license for encrypted content exists, in response to the requesting checking of the license; and if it is determined that the license exists, requesting transmission of encrypted content, decrypting the encrypted content, and playing the decrypted content.

This application claims priority from Korean Patent Application No. 10-2007-0019227 filed on Feb. 26, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to a digital rights management (DRM) system, and more particularly, to dividing the function of a DRM terminal device into a security domain in which security is required, and a non-security domain in which security is not required.

2. Description of the Related Art

In general, DRM technologies protect and manage the rights of a digital content author. In DRM technologies, content is kept in an encrypted format in a content providing server, and encrypted content and key information for decoding encrypted content are transmitted to a corresponding user at a time when a user requests purchase of content. For example, DRM stipulates a number of times digital content can be played back, whether digital content can be copied or not, or a number of times digital content can be copied.

FIG. 1 illustrates a related art DRM system.

As illustrated in FIG. 1, a related art DRM system includes a content server 10, a license server 20, and a client 30.

The content server 10 packages encrypted content together with DRM information and provides the encrypted content packaged together with DRM information to a user. The license server 20 provides rights for using a DRM package and a key for decoding to a user (for example, the client 30).

In addition, DRM content (package) is provided to the client 30 when the user downloads (streams) DRM content (package) from the content server 10 through the Internet, a license for DRM content is obtained from the license server 20, the DRM content is decoded using a key included in the license and then, the decoded DRM content is played back through a renderer.

The user (for example, the client 30) must receive a license for DRM content from the license server 20 in order to use content provided from the content server 10. An encryption key and usage rights are created and are expressed as a license depending on whether the user and a licensee of the content are identical with each other.

The user (for example, the client 30) decodes the DRM package using the license and plays back content through a rendering application. Since rights for using the content are stipulated in the license, a DRM controller restricts content usage according to usage rights.

However, in related art DRM terminal devices, software for driving the DRM is exposed to users so that there is a danger that a malicious user may change a DRM terminal system arbitrarily so as to use content illegally. Due to such a structural problem, the following three disadvantages are present in the related art.

First, a malicious user may edit rights and use content illegally.

In order to use DRM content, a key which is included in a license and rights in which rights for playing back content are described, are needed. When information described in rights can be modified by the user, illegal usage of content cannot be prevented using the rights.

For example, rights indicating that content that is supposed to be played back only once may be illegally changed into rights for playing back the content continuously. In related art techniques, an encryption technique has been used to prevent such an attack. However, if there is malicious software (i.e., “malware”) that can scan contents recorded in memory, the contents may be leaked or modified. Thus, in any related art technique, if malware and DRM software to be protected are run on the same operating system (OS), access of memory caused by malware cannot be fundamentally prevented.

Second, control of content may be disturbed by damage to a DRM controller.

The DRM controller has the function of restricting content usage according to contents recorded in the rights. However, the function of the DRM controller may be disturbed by malicious software (malware). If control of content usage based on contents of the rights is prevented, content having no usage rights can be used without any restriction and therefore, a problem occurs. To prevent the problem, the user must protect codes of DRM software and a domain in which DRM software is executed, so that the codes of DRM software are not changed. However, such protection of codes is difficult to accomplish in related art systems using related art techniques.

Third, content may be leaked illegally through a network or mobile disc.

If the malicious user stores the contents of decoded content in memory using malware, in related art systems, the contents may be leaked to an external user using the network or mobile disc.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and a method for providing a security domain in which digital rights management (DRM) content is protected by dividing a DRM software domain of a host device into a security domain in which security is required, and a non-security domain in which security is not required.

The present invention also provides an apparatus and a method for providing a security domain in which the stability of a DRM system is guaranteed.

These and other objects of the present invention will be described in or be apparent from the following description of exemplary embodiments.

According to an aspect of the present invention, there is provided an apparatus for providing a security domain, the apparatus comprising, a security domain which is not connected to an external system and which manages a DRM (digital rights management) license requiring security, a non-security domain which can be connected to the external system and manages encrypted DRM content, and a virtual controller which transmits instruction messages to the security domain and the non-security domain.

According to another aspect of the present invention, there is provided a method for providing a security domain by which encrypted content is played back by an apparatus divided into a security domain and a non-security domain, the method including requesting checking of a license for encrypted content, checking whether the license for encrypted content exists or not according to the request, and if the license exists as a result of checking, requesting transmission of encrypted content, and decoding encrypted content and playing the content back.

### BRIEF DESCRIPTION OF THE DRAWINGS

The above and other aspects of the present invention will become more apparent by describing in detail exemplary embodiments thereof with reference to the attached drawings in which:

FIG. 1 illustrates a related art DRM system;

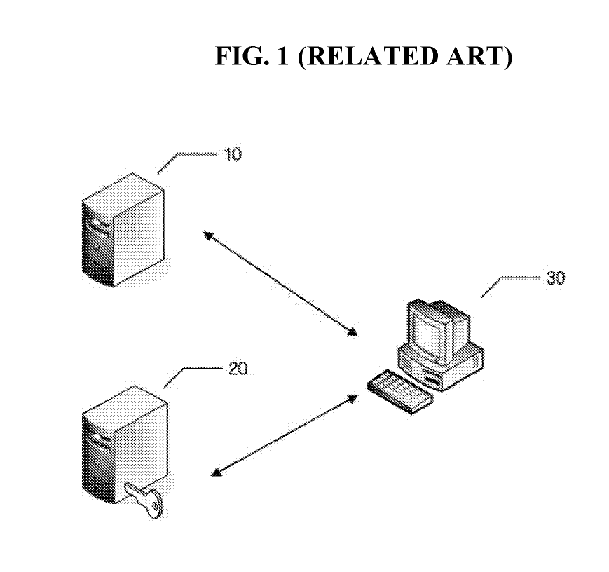

FIG. 2 is an internal block diagram of an apparatus for providing a security domain according to an exemplary embodiment of the present invention;

FIG. 3 is a flowchart illustrating a method for providing a security domain according to an exemplary embodiment of the present invention; and

FIG. 4 illustrates an operation of obtaining a license according to method illustrated in FIG. 3.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments of the present invention and the accompanying drawings. The present inventive concept may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

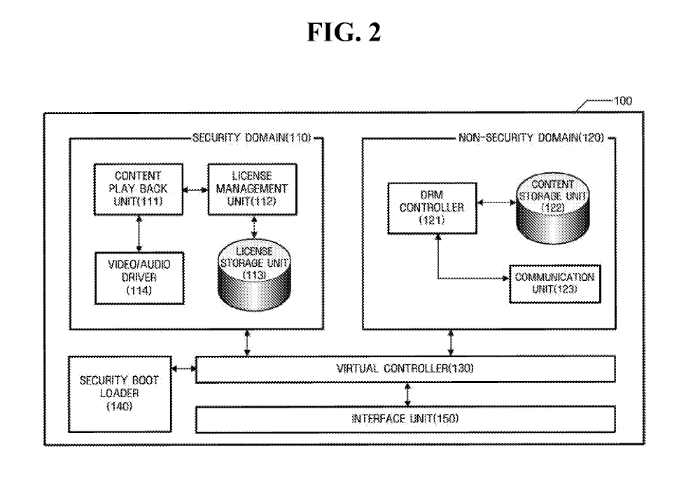

FIG. 2 is an internal block diagram of an apparatus for providing a security domain according to an exemplary embodiment of the present invention.

Referring to FIG. 2, an apparatus 100 for providing a security domain (hereinafter, referred to as a host device) includes a security domain 110, a non-security domain 120, a virtual controller 130, a security boot loader 140, and an interface unit 150.

The host device 100 is a device that can play back a content object by consuming a license and a rights object. The host device 100 may be a portable content playback device, such as a mobile phone, a personal digital assistant (PDA), an MP3 player, or a stationary content playback device, such as a desktop computer or a digital TV.

The security domain 110 is a domain in which an application requiring security and an operating system (OS) for driving the application are located. A change of data that exists in the security domain 110 may be performed by the application of the security domain 110 or the OS of the security domain 110 but may not be performed by an external input.

In addition, the security domain 110 is not connected to an external system via a network and data cannot be stored in a mobile medium. The security domain 110 exchanges data only with the virtual controller 130. Thus, a user may install software only in the non-security domain 120 and searching and downloading of DRM content as well as downloading of the license are executed in the non-security domain 120.

From the viewpoint of the security domain 110, since the non-security domain 120 also corresponds to an external input, the application, the OS, and data of the security domain 110 are not affected by an application and an OS that exist in the non-security domain 120.

The security domain 110 includes a content playback unit 111, a license management unit 112, a license storage unit 113, and a video/audio driver 114.

The content playback unit 111 decodes encrypted content using a key included in the license and then plays back the decoded content.

The license management unit 112 manages the license issued from a license server and checks whether content playback rights are valid or not. In addition, the license management unit 112 requests encrypted content from the non-security domain 120.

The license storage unit 113 stores the license including a key for decoding the encrypted content and rights for using the content.

The video/audio driver 114 outputs content that is played back by the content playback unit 111.

The non-security domain 120 is a domain in which an application that does not require security and an OS for driving the application are located. A change of data that exists in the non-security domain 120 may be performed by an application of the non-security domain 120 or the OS of the non-security domain 120 and may also be performed by an external input.

For example, a virus program and malicious software (malware) such as spyware or adware, which correspond to programs input from the outside, may be installed in the non-security domain 120 and may not be installed in the security domain 110.

The non-security region 120 includes a DRM controller 121, a content storage unit 122, and a communication unit 123.

The DRM controller 121 communicates with a content server and a license server via a network and receives DRM content and a license from the content server and the license server, respectively.

In addition, the DRM controller 121 requests the security domain 110 to playback DRM content and transmits DRM content to the security domain 110.

The content storage unit 122 stores DRM content transmitted from the content server and metadata of DRM content.

The communication unit 123 communicates with the content server and the license server via the network.

The OS of the security domain 110 and the OS of the non-security domain 120 may be different types of OS. As such, even if malware driven in the non-security domain 120 by the OS of the non-security domain 120 is transited to the security domain 110, malware is not driven by the OS of the security domain 110, which is a different OS from the OS of the non-security domain 120.

In addition, the security domain 110 and the non-security domain 120 may be logical domains or physical domains.

For example, the OS and the application must be loaded into memory so as to operate, and part of the memory is allocated to the security domain 110 and the other part of the memory is allocated to the non-security domain 120. Through such memory allocation, the virtual controller 130 has access to the security domain 110 or the non-security domain 120 using an address of memory.

The virtual controller 130 transmits a request instruction transmitted from the security domain 110 to the non-security domain 120 and transmits a query and request instruction transmitted form the non-security domain 120 to the security domain 110. In other words, the security domain 110 communicates only through the virtual controller 130.

In addition, the virtual controller 130 transmits an instruction input to or output from the interface unit 150 to the non-security domain 120.

That is, the virtual controller 130 intercepts a direct access to the interface unit 150 caused by the security domain 110 or the non-security domain 120 and performs communication with only one of the security domain 110 and the non-security domain 120.

In general, a boot loader denotes a program that completes all related work for correctly booting a kernel while being executed before booting of an operating system (OS) and finally boots the operating system (OS).

The security boot loader 140 performs a same operation as an operation of a general boot loader and also performs an operation of checking whether the virtual controller 130 and the security domain 110 are changed or not.

That is, the security boot loader 140 checks that the security domain 110 has not been changed, through the virtual controller 130 or a trusted protection module (TPM).

For example, when the security domain 110 is damaged by an external input or an internal error, security information that exists in the security domain 110 may be leaked. To prevent the malfunction of the security domain 110, the security boot loader 140 checks a state of the security domain 110 before the host device 100 performs an operation of playing back a content object by consuming a license and a rights object.

If the security domain 110 is damaged, the security boot loader 140 transmits an indication of the damage of the security domain 110 to the virtual controller 130 so that the damaged OS does not operate.

A user's instruction is input to the interface unit 150 and the interface unit 150 outputs the working results of the security domain 110 and the non-security domain 120. The interface unit 150 may include input units such as a button, a touch pad, and a wheel, and output units, such as a liquid crystal display (LCD), a light emitting diode (LED), and an organic light emitting display (OLED).

The term ‘module’, as used herein, denotes, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

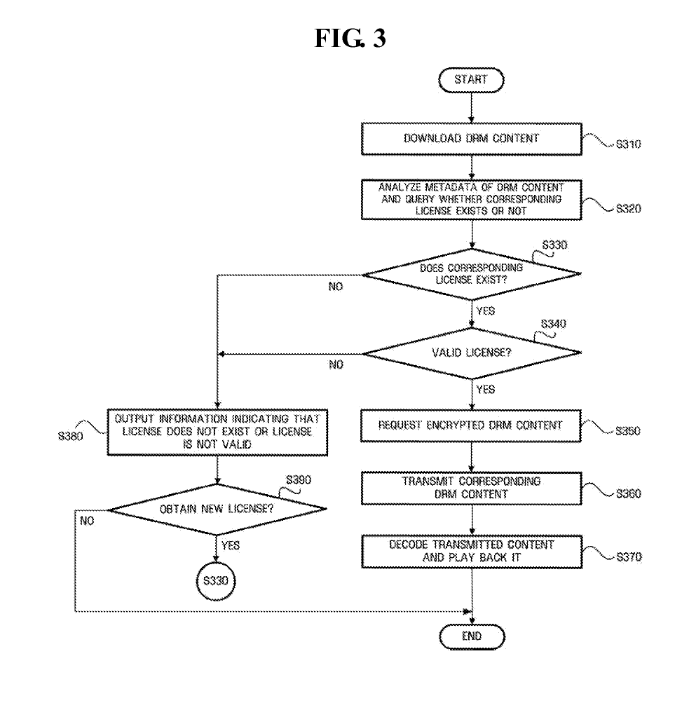

FIG. 3 illustrates a method for providing a security domain according to an exemplary embodiment of the present invention. Here, it is assumed that, before the host device 100 performs an operation of playing back a content object by consuming a license and a rights object, the host device 100 has checked whether the security domain 110 has not been changed, through the security boot loader 140.

DRM content from the content server is downloaded and stored in a download and streaming format in the non-security domain 120 in response to a user's request (S310). Here, the user's request is input to the interface unit 150 and is transmitted by the virtual controller 130 to the DRM controller 121 of the non-security domain 120.

To execute downloaded DRM content, the DRM controller 121 analyzes metadata of DRM content and queries whether a license for decoding corresponding DRM content exists in the security domain 110, based on the analyzed result (S320).

Subsequently, the virtual controller 130 transmits the query of the DRM controller 121 of the non-security domain 120 to the license management unit 112 of the security domain 110. A communication path between the non-security domain 120 and the security domain 110 is provided by the virtual controller 130 and thus is safe from external malware.

The license management unit 112 searches whether a license for corresponding DRM content exists in the license management unit 113 or not. (S330)

As a result of searching, if it is determined that a license for corresponding DRM content exists in the license storage unit 113 (S330), the license management unit 112 checks whether the searched license is valid or not. (S340). Checking of the validity of the license can be achieved by checking the expiration date of the license, but may also be achieved by using other validity-checking methods.

As a result of checking validity, if it is determined that the corresponding license is a valid license (S340), the license management unit 112 requests the DRM controller 121 of the non-security domain 120 to transmit the encrypted content. (S350).

The virtual controller 130 transmits a signal for requesting content transmission of the license management unit 112 of the security domain 120 to the DRM controller 121 of the non-security domain 120.

The DRM controller 121 of the non-security domain 120 searches encrypted corresponding DRM content at the content storage unit 122 and transmits corresponding DRM content to the security domain 110 through the virtual controller 130 (S360).

The content playback unit 111 of the security domain 110 receives encrypted content from the virtual controller 130 and decodes the encrypted content using a key included in the license of transmitted content and plays the content back (S370). Decoded content is output to the video/audio driver 114. In this case, the video/audio driver 114 is provided in the security domain 110 and is not shared with the non-security domain 120.

As a result of performing operation S330, if it is determined that the license of corresponding DRM content does not exist in the license storage unit 113, or as a result of performing operation S340, if it is determined that the searched license is not valid, information indicating that the corresponding license does not exist in the license storage unit 113 or that the searched license is not a valid license is output to the interface unit 150 (S380).

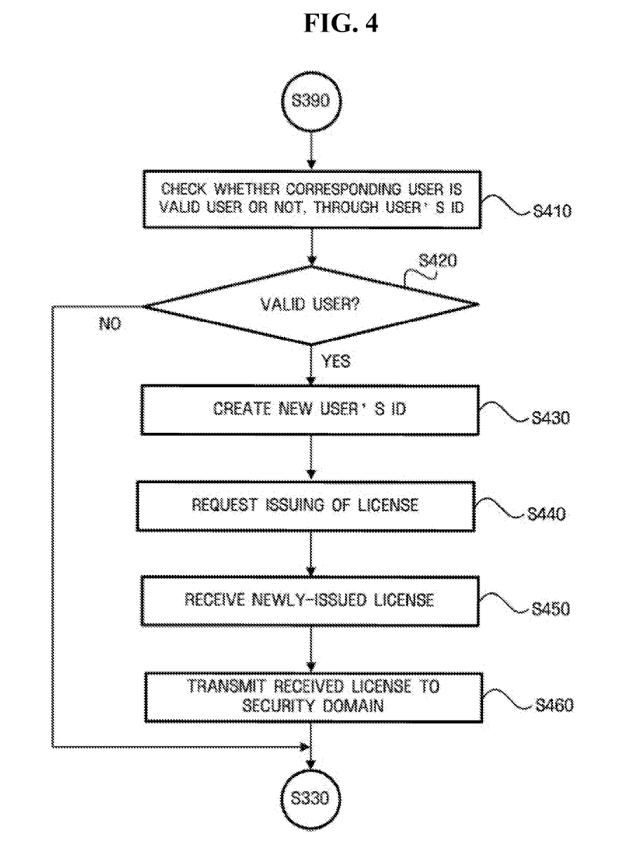

The user is then queried whether the user would like to obtain a new license. (S390). If it is determined that the user obtains a new license (S390), operations S330 through S380 are performed. The operation of obtaining the new license will be described with reference to FIG. 4.

If it is determined that the user does not obtain the new license, since encrypted content cannot be decoded, corresponding content cannot be played back and the operation of playing back DRM content is terminated.

FIG. 4 illustrates an operation of obtaining a license of the method illustrated in FIG. 3.

Referring to FIG. 4, the security boot loader 140 checks whether a corresponding user is a valid user, through an identifier (ID) peculiar to the user (S410). Here, whether the user is a valid user or not can be determined through a user's ID and a password input.

As a result of checking, if it is determined that the user is a valid user (S420), the security boot loader 140 creates a new user's ID using the user's ID and an ID of the host device 100 (S430). The DRM controller 121 transmits the new user's ID and a content ID to be issued, to the license server to request the license server to issue of the license (S440). The content ID can be known through analysis of metadata of content.

The license server searches rights information of corresponding content to determine whether the license is to be re-issued or purchase of a new license is to be requested and then transmits messages (for example, a message for re-issuing the license and a message for requesting purchase of a new license) to the host device 100. An external interface for issuing a license is included in the non-security domain 120 and the security domain 110 does not include an external interface.

A newly-issued license (or re-issued license) is transmitted to the host device 100 from the license server and the transmitted license is received by the non-security domain 120 (S450).

The license received by the non-security domain 120 is transmitted to the license storage unit 113 of the security domain 110 through the virtual controller 130 (S460) and is stored in the license storage unit 113. Since the external interface does not exist in the security domain 110, the newly-issued license that is transmitted to the non-security domain 120 through the virtual controller 130 is provided to the security domain 110. The newly-issued license is exposed to the non-security domain 120 but a private key for decoding an encrypted license does not exist in the non-security domain 120 and thus, the issued license cannot be used.

If it is determined in operation S420 that the user is not a valid user, a new user's ID is not created and thus, a new license cannot be issued.

The apparatus and method for providing a security domain according to exemplary embodiments of the present invention have one or more effects, as listed below.

A security attack that may occur in a terminal device using DRM content is prevented such that usage of DRM content is prevented and a DRM system is protected from the outside.

In addition, the security reliability of a DRM terminal is improved such that the reliability of a DRM framework is reinforced, and the usage of legal content is induced such that content distribution and market revitalization may be affected positively.

While the present inventive concept has been particularly shown and described with reference to exemplary embodiments thereof, it will be understood by those skilled in the art that various changes in form and details may be made therein without departing from the spirit and scope of the invention as defined by the following claims and equivalents thereof

What is claimed is:

1. An apparatus for providing a security domain, the apparatus comprising:
a security domain which is not connected to an external system and which manages a digital rights management (DRM) license requiring security;
a non-security domain which can be connected to the external system and which manages encrypted DRM content; and
a virtual controller which controls the security domain and the non-security domain.

2. The apparatus of claim 1, wherein the virtual controller controls the security domain and the non-security domain by selectively transmitting instruction messages to the security domain and the non-security domain.

3. The apparatus of claim 1, wherein the security domain comprises:
a license management unit which manages the DRM license including a key for decoding encrypted content and rights for using encrypted content; and
a content playback unit which decodes encrypted content using the license.

4. The apparatus of claim 1, wherein the security domain communicates only with the virtual controller.

5. The apparatus of claim 1, wherein, in the security domain, data cannot be stored in a mobile medium.

6. The apparatus of claim 2, wherein the virtual controller selectively transmits the instruction messages by not transmitting instruction messages input from the external system to the security domain.

7. The apparatus of claim 1, further comprising a security boot loader which checks whether the security domain and the virtual controller are changed or not.

8. A method for playing encrypted content in a security domain of an apparatus having a security domain and a non-security domain, the method comprising:
requesting checking of a license for encrypted content;
checking whether the license for encrypted content exists, in response to the requesting checking of the license; and
if it is determined that the license exists, requesting transmission of encrypted content, decrypting the encrypted content, and playing the decrypted content.

9. The method of claim 8, wherein the security domain is not connected to an external system.

10. The method of claim 8, wherein, in the security domain, data cannot be stored in a mobile medium.

11. The method of claim 8, wherein the license for the encrypted content is checked and encrypted content is played back only in the security domain.

12. The method of claim 8, wherein, in the security domain, a message for checking the license is received through the virtual controller and the license for the encrypted content is transmitted through the virtual controller.

13. The method of claim 8, further comprising, if the license does not exist, issuing a new license.
